(19) United States
(12) Patent Application Publication
(10) Pub. No.: US 2009/0012798 A1
(43) Pub. Date: Jan. 8, 2009

(54) TRAVELER SAFETY INFORMATION CORRELATION SYSTEM AND ASSOCIATED METHODS

(75) Inventors: James T. McConnell, North Richland Hills, TX (US); Robert Molina, Glen Gardner, NJ (US); Shaikh Elahi, Summerset, NJ (US)

Correspondence Address: VERIZON;PATENT MANAGEMENT GROUP, 1320 North Court House Road, 9th Floor, ARLINGTON, VA, 22201-2909, US

(73) Assignees: Verizon Corporate Services Group, Inc., Basking Ridge, NJ (US); Verizon Corporate Services Group, Inc., Arlington, VA (US)

(21) Appl. No.: 11/772,557

(22) Filed: Jul. 2, 2007

(51) Int. Cl. G06Q 10/00; G06F 17/30

(52) U.S. Cl. 705/1; 707/104.1

(57) ABSTRACT

A traveler safety information correlation system is provided. An interactive, real-time mapping tool is combined with traveler location and alert information data sources. Recorded locations corresponding to human assets are overlaid on geographical maps enabling an operator to determine real or near real-time locations of human assets, such as an organizations employees. Traveler location information may obtained from computerized reservation systems, credit card processing systems, cellular and wireless computer networks, and/or other systems. The traveler safety information correlation system may also be used to generate alerts and to deliver information messages to human assets.

### BACKGROUND OF THE INVENTION

With the globalization of the economy it is now common for even relatively small organizations to have human assets, i.e., employees/contractors/consultants, at various locations around the globe at any given moment. It is difficult for an organization to stay in touch with its assets as they become geographically more dispersed and located in regions having varying levels of infrastructure, and to get emergency information to them as various natural, civil and political disasters occur.

Typically, when a person travels for business, even in countries with emerging economies, they leave digital footprints every step of the way, from the time they leave their city of departure until they return. These digital footprints may be in the form of airline manifests, cellular phone records, credit card transaction records, internet service provider records, and even independent GPS tracking devices which some travelers may use to allow others to track their location. Even in third world countries, services such as wireless phone access, Internet access and credit card transaction processing have become ubiquitous. The mere fact that this data exists does not mean it can be accessed in a useful way. A problem is that this data from these systems is all maintained on separate systems and is not accessible in the aggregate to determine a traveler's current location on demand. Also, to the extent that any of these systems are linked, they are typically not tied to any other system that monitors for travel related alerts. Accordingly, there is a need for an integrated system to assist an organization in monitoring travel related alerts and in tracking, locating and communicating information to its human assets.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 is a system diagram of an exemplary network-based traveler safety information correlation system according to various embodiments of the disclosure.

FIG. 2 is a system diagram of exemplary server side components of a traveler safety information correlation system according to various embodiments of the disclosure.

FIG. 3 is a block diagram illustrating an exemplary set of location data sources for determining human asset location information according to at least one embodiment of the disclosure.

FIG. 4 is block diagram illustrating an exemplary set of alert data sources for determining location-based safety information according to at least one embodiment of the disclosure.

FIG. 5 is a flow chart of an exemplary method for determining traveler safety with a traveler safety information correlation system according to at least one embodiment of the disclosure.

FIG. 6 is a block diagram of an exemplary traveler safety information correlation system according to at least one embodiment of the disclosure.

FIG. 7 is a exemplary graphical user interface menu of a traveler safety information correlation system according to at least one embodiment of the disclosure.

FIG. 8 is an exemplary graphical user interface for checking for travel advisories with a traveler safety information correlation system according to at least one embodiment of the disclosure.

FIG. 9 is an exemplary graphical user interface of a traveler safety information correlation system including a map having travel advisory and traveler location superimposed thereon, according to at least one embodiment of the disclosure.

FIG. 10 is an exemplary graphical user interface of a traveler safety information correlation system according to at least one embodiment of the disclosure.

FIG. 11 is an exemplary graphical user interface of a traveler safety information correlation system including a traveler profile according to at least one embodiment of the disclosure.

FIG. 12 is an exemplary graphical user interface of a traveler safety information correlation system including a traveler search function according to at least one embodiment of the disclosure.

FIG. 13 is an exemplary graphical user interface of a traveler safety information correlation system including a traveler location information detail according to at least one embodiment of the disclosure.

FIG. 14 is an exemplary graphical user interface of a traveler safety information correlation system including a traveler alert messaging function according to at least one embodiment of the disclosure.

### DETAILED DESCRIPTION

The following description is intended to convey a thorough understanding of the embodiments described by providing a number of specific embodiments and details involving systems and methods for providing a traveler safety information correlation system. It should be appreciated, however, that the present disclosure is not limited to these specific embodiments and details, which are exemplary only. It is further understood that one possessing ordinary skill in the art, in light of known systems and methods, would appreciate the use of the embodiments of the invention for its intended purposes and benefits in any number of alternative embodiments, depending upon specific design and other needs.

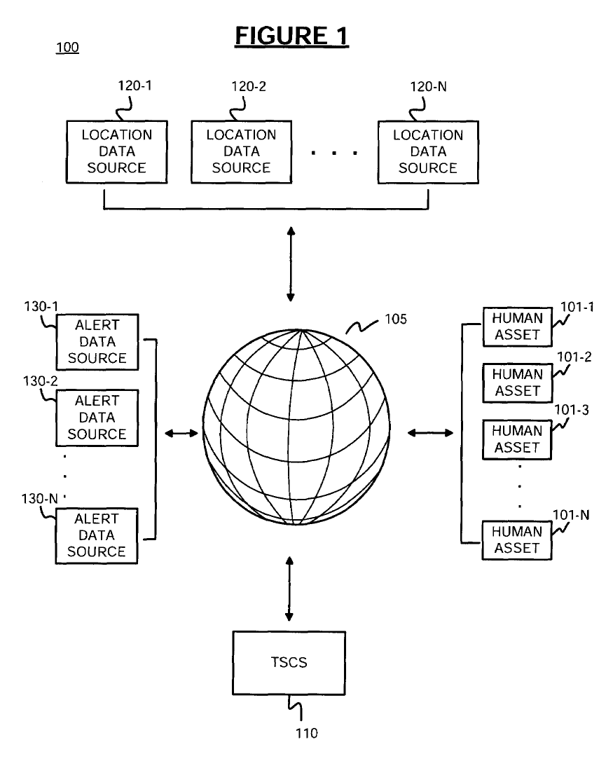

Referring now to FIG. 1, this Figure is a system diagram of an exemplary network-based traveler safety information correlation system according to various embodiments of the disclosure. The exemplary system 100 of FIG. 1 includes a plurality of human assets 101-1, 101-2, 101-3, . . . , 101-N, a traveler safety control system 110, a plurality of location data sources 120-1, 120-2, . . . , 120-N, and a plurality of alert data sources 130-1, 130-2, . . . , 130-N, communicatively coupled to each other via a network 105.

Each of the human assets 101-1, 101-2, 101-3, . . . , 101-N may comprise human assets such as employees of a particular organization who are traveling at one or more different locations around the network 105. Each human asset 101-1, 101-2, 101-3, . . . 101-N may communicate with the network 105 directly, such as by phone, electronic mail, network browser, etc. Also, each human asset 101-1, 101-2, 101-3, . . . 101-N may communicate with the network 105 indirectly, such as by GPS tracking, transactional tracking (i.e., credit/debit card usage), wireless phone tracking (wireless base station correlation). Thus, the network 105 does not just represent a wide area communication network such as the Internet, but rather the world in general which is comprised of many different networks.

The location data sources 120-1, 120-2, . . . , 120-N may comprise a cellular telephone network computer system, a credit card transaction processing system, an Internet service provider system, a computerized reservation system, a government agency passenger manifest system (i.e., Federal Aviation Administration—FAA), or other electronic data system that accumulates data such as “electronic footprints” left by the human assets 101-1, 101-2, 101-3, . . . , 101-N as they travel around the network 105.

Similarly, the alert data sources 130-1, 130-2, . . . , 130-N may comprise one or more newswires, Internet search engines, government travel safety alert systems, weather systems or other network-based systems that provide up-to-date information on potential travel hazards including weather, civil/political unrest, and natural disasters.

The traveler safety control system (TSCS) 110 may comprise one or more computer systems that receive data from the plurality of location data sources 120-1, 120-2, . . . , 120-3 and alert data sources 130-1, 130-2, . . . , 130-3 via the network 105. This data may in various embodiments be received periodically and/or in real-time and may be pushed to or pulled by the TSCS 110. An operator may use the TSCS 110 as a gateway to access information on potential travel advisories, to locate human assets, and to communicate information to the human assets. The operator may use the TSCS 110 to monitor for situations that could affect one or more of the human assets 101-1, 101-2, 101-3, . . . , 101-N. Also the TSCS 110 may operate autonomously to alert an operator and/or one or more of the human assets 101-1, 101-2, 101-3, . . . , 101-N of the existence of a situation from one or more of the alert data sources 130-1, 130-2, . . . , 130-N that could impact the one or more of the human assets 101-1, 101-2, 101-3, . . . , 101-N.

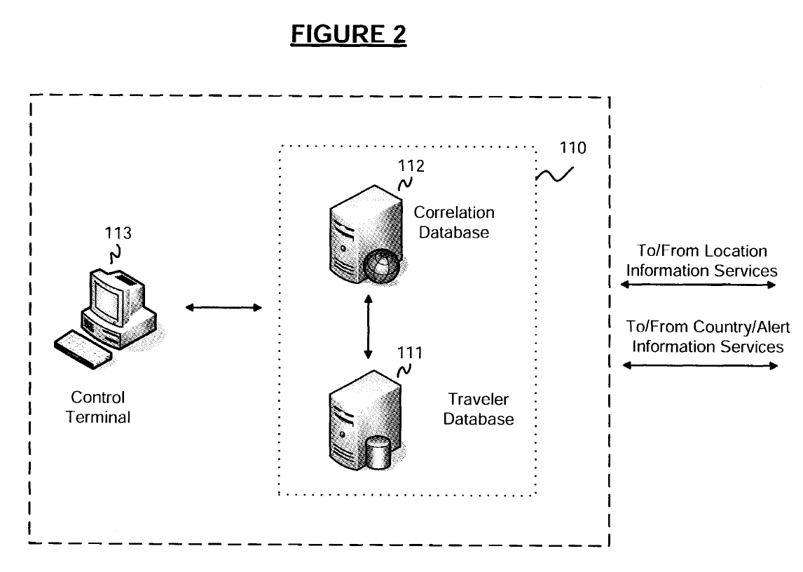

Referring now to FIG. 2, this Figure is an exemplary system diagram of server side components of a traveler safety information correlation system according to various embodiments of the disclosure. The system may be the TSCS 110 of FIG. 1. In various embodiments, the system 110 may comprise a traveler database system 111, a correlation database 112, and a control terminal 113. The traveler database 111 may maintain information on an organizations' human assets. For example, the traveler database 111 may be correlated to a human resources database of an organization. In addition, the traveler database 111 may maintain identification information associated with each traveler so that the system 110 may obtain information about the traveler from the plurality of location data sources 120-1, 120-2, . . . , 120-N. For example, the traveler database 111 may maintain a traveler profile for one or more employees of an organization, including the one or more employee's name, address, date of birth, wireless phone number, computer identification number, email address, credit card number(s), copy of passport, and other information. One or more of these information fields may be used by the system 110 to obtain location information from the plurality of location data sources 120-1, 120-2, . . . , 120-N.

The correlation database 112 may correlate the information from the traveler database 111, the plurality of location data sources 120-1, 120-2, . . . , 120-N, and the plurality of alert data sources 130-1, 130-2, . . . , 130-N. For example, the correlation database 112 may determine whether a particular set of alert information is relevant to any travelers in the database. This may comprise obtaining traveler information from the traveler database to determine if any travelers are in or near the location of the alert. This may also comprise performing a location search on some or all travelers using data from the traveler database 111 and the plurality of location data sources 120-1, 120-2, . . . , 120-N to determine if any travelers have a current location near the location associated with alert.

It should be appreciated that the traveler database 111 and the correlation database 112 may be integrated into a single system. Also, the traveler database 111 and the correlation database 112 may located at diverse geographic locations and be communicatively coupled to one another, such as, over the network 105 of FIG. 1. The implication of FIG. 2 that the traveler database 111 and the correlation database 112 are located together is for ease of illustration purposes only.

The control terminal 113 may be a single, fixed terminal such as a computer station in an organization's headquarters. Also, the control terminal 113 may be any network-enabled computer that is able to communicate with the traveler database 111 and correlation database 112 to monitor traveler safety information and to locate travelers. In such embodiments, the control terminal 113 may be a personal computer, laptop computer, tablet computer, personal digital assistant (PDA), computer-enabled phone, or other computing device, thereby enabling an operator to interact with the system 110 from any network accessible point. In various embodiments, the control terminal 113 may be executing a specific computer program dedicated to the system 110. In other embodiments, the control terminal 113 may be executing a more general program such as an Internet web browser.

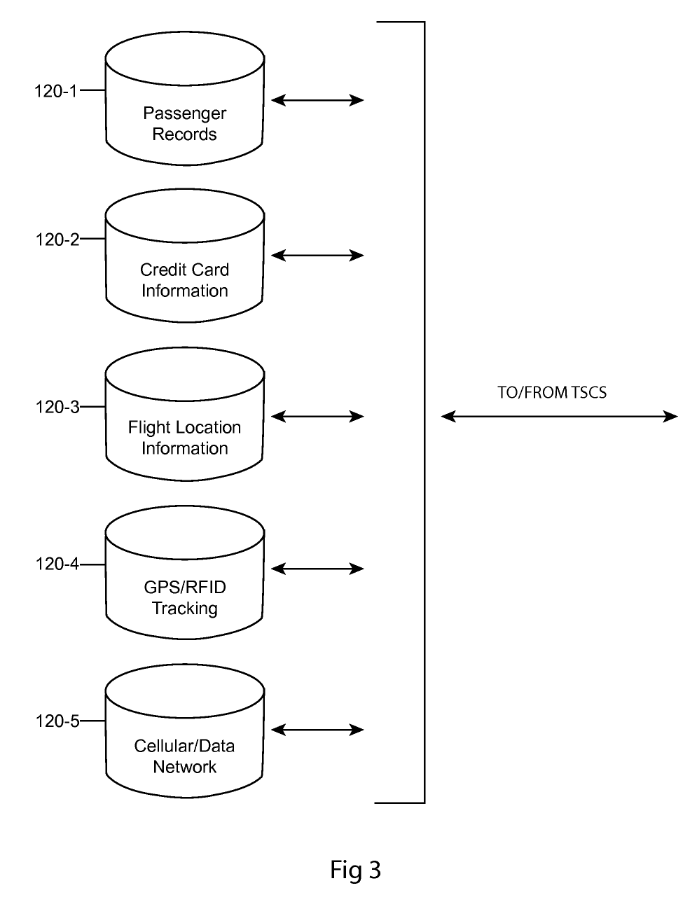

Referring now to FIG. 3, this Figure illustrates a block diagram of an exemplary set of location data sources for determining human asset location information according to at least one embodiment of the disclosure. In the example of FIG. 3, a plurality of location sources 120-1, 120-2, 120-3, 120-4, and 120-5 corresponding to a passenger records system, credit card transaction processing system, flight location information system, GPS/RFID tracking system and cellular/data network system respectively are shown. It should be appreciated that these represent the types of location information data sources that can be used with the various embodiments of the disclosure in conjunction with one or more real-time graphical mapping systems such as GOOGLE EARTH based on Keyhole Markup Language (KML). The sources shown in FIG. 3 are neither exhaustive nor necessarily inclusive, but rather exemplary. Each source 120-1, 120-2, 120-3, 120-4, and 120-5 may represent a computer system, database, or other electronic data structure and may also include the necessary network interconnection hardware and software. Each source 120-1, 120-2, 120-3, 120-4, and 120-5 may interface with the TSCS 110 in a unique proprietary way or through a standardized protocol. For example, the TSCS 110 may poll one or more of the sources 120-1, 120-2, 120-3, 120-4, and 120-5 with information on one or more travelers, such as name, social security number, mobile phone number, credit card number, computer ID number, etc. In response, the corresponding systems 120-1, 120-2, 120-3, 120-4, and 120-5 may return whatever information that system maintains on the one or more travelers. This may occur simultaneously or in series. That is, the system 110 may poll the sources 120-1, 120-2, 120-3, 120-4, and 120-5 in a predetermined or dynamic order. It should be appreciated that more, fewer and even different sources than the sources 120-1, 120-2, 120-3, 120-4, and 120-5 shown in FIG. 3 may be used with the various embodiments of the disclosure.

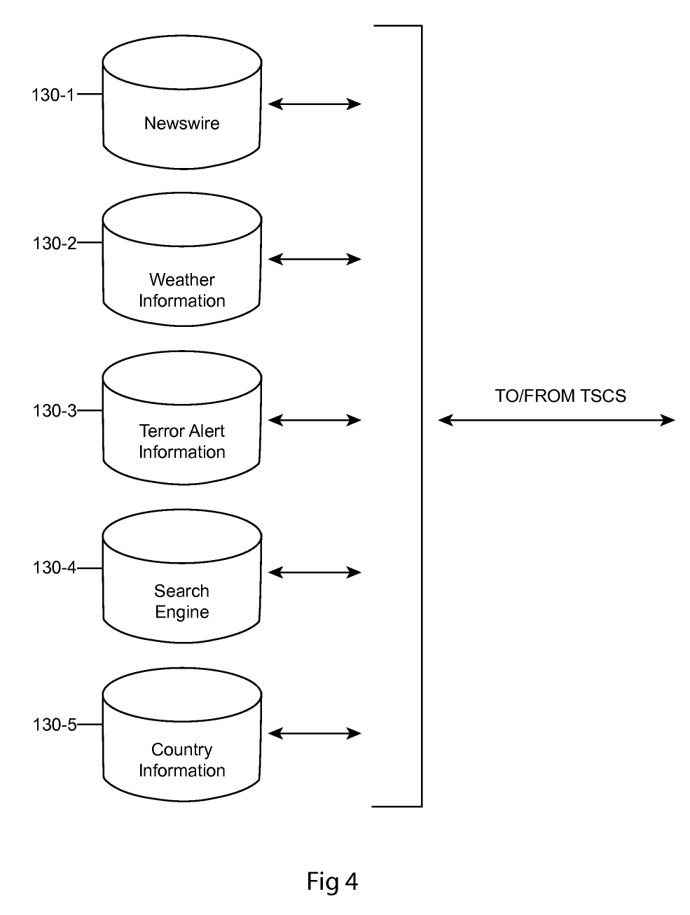

Referring now to FIG. 4, this Figure is a block diagram illustrating an exemplary set of alert data sources for determining location-based safety information according to at least one embodiment of the disclosure. In the example of FIG. 4, five alert data sources 130-1, 130-2, 130-3, 130-4, and 130-5 are shown, corresponding to a newswire system, weather information system, terror alert information system, Internet search engine, and country information respectively. As with the exemplary data sources of FIG. 3, it should be appreciated that the sources of FIG. 4 merely represent the types of alert information data sources that can be used with the various embodiments of the disclosure. The sources shown in FIG. 4 are neither exhaustive nor necessarily inclusive, but rather exemplary. Each source 130-1, 130-2, 130-3, 130-4, and 130-5 may represent a computer system, database, or other electronic data structure and may also include the necessary network interconnection hardware and software. Each source 130-1, 130-2, 130-3, 130-4, and 130-5 may interface with the TSCS 110 in a unique proprietary way or through a standardized protocol. For example, the TSCS 110 may poll one or more of the sources 130-1, 130-2, 130-3, 130-4, and 130-5 for information on a particular location, or may query for any alert information and then make a determination at the TSCS 110 as to whether the alert is relevant to any traveler. The system 110 may poll one or more of the sources 130-1, 130-2, 130-3, 130-4 and 130-5 periodically, or one or more of the sources may automatically supply alert information to the system 110 as it becomes available. It should be appreciated that more, fewer and even different sources than the sources 130-1, 130-2, 130-3, 130-4, and 130-5 shown in FIG. 4 may be used with the various embodiments of the disclosure.

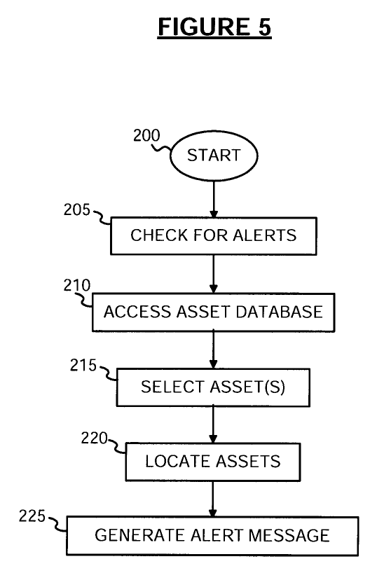

FIG. 5 is a flow chart of an exemplary method for determining traveler safety with a traveler safety information correlation system according to at least one embodiment of the disclosure. The method begins in block 200. In block 205, a check for alerts is performed. This may comprise actively polling one or more alert data sources, such as the sources 130-1, 130-2, 130-3, 130-4 and 130-5 shown in FIG. 4. This may also comprise receiving alert information from one or more alert sources.

In block 210 one or more human asset databases is accessed. This may comprise accessing a human resources database, a traveler information database, combinations of these or any other database that maintains information on an organizations personnel. This may include identification information such as name, address, social security number, credit card number, wireless phone number, etc. This may also include information corresponding to known travel plans of one or more human assets. In block 215, one or more assets are selected. This may comprise selecting assets who are known to be traveling in a particular area related to the alert. This may also comprise selecting a group of assets, such as all outside sales personnel. This may also comprise selecting a larger group such as all employees at location “x”, where “x” is a city, state, country, region, etc.

In block 220 the assets selected in block 215 are located. As discussed herein, this may comprise sending information taken from a database of traveler information corresponding to each asset to one or more location information sources. For example, a name, social security number and credit card number may be sent to a credit card transaction processing system to obtain a list of recent credit card transactions from which a location of the traveler may be determined. As another example, a name and a mobile phone number may be sent to a wireless phone service provider system to determine a location of one or more wireless phone towers accessed by the traveler. As yet another example, this may comprise accessing a government or travel service provider passenger manifest system to determine whether or not one of the human assets are or were on a plane, train, ship, etc. In various embodiments, information corresponding to one or more location sources may be received in raw, unprocessed form, and a module at the server side may process this information to determine a location of each of the affected human assets, that is, to correlate the alert information to the traveler information to determine which if any assets are potentially affected by the alert and to make sure that all of these assets are accounted for.

In block 225, an alert message may be generated if necessary. This may comprise sending a message to each of the affected assets via phone, SMS, email, facsimile or by other means. The alert message may comprise a request for the asset to call a particular number or send a reply acknowledgement that the asset is alright. The alert may also include information corresponding to the alert as well as instructions for the asset, such as alternative travel plans, safety information, etc.

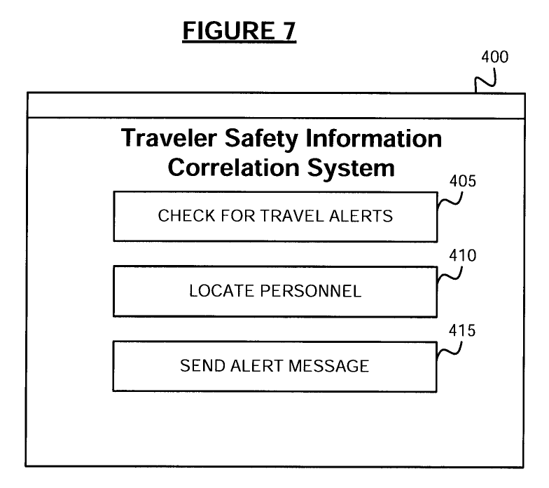

The steps performed in FIG. 5 may be performed automatically by automated systems, with human assistance, or may be performed manually, that is with a human operator driving the operation of the automated systems. For example, through a user interface, an operator may actively check for alerts by polling one or more alert data sources to determine if any new alerts exist, or by checking an electronic mail box, web site, or other interface to determine. An operator may view the alerts and make a determination his/herself as to the potential relevance of any alerts. For example, the operator may see a hurricane warning for the southeastern United States. The operator may then access one or more asset databases to determine whether this alert is relevant to any of an organization's human assets. This determination may be made based on information other than near or real-time location information. For example, this decision may be made based on travel plan information. The operator may then select one or more human assets, or a group of human assets to locate. This may cause one or more pieces of identification information corresponding to each human asset to be sent out electronically to one or more location information sources. Any responses to these location information sources may be analyzed by automated methods or may an analyzed by a system operator, or both, to determine a precise location of each asset. In at least one embodiment, the operator may view a map including a map point for each asset. As is discussed in greater detail in the context of FIGS. 7-13, the map point may comprise an embedded link, that when selected, causes the detailed location and profile information for that asset to be displayed for the operator. Any alert information may also be displayed on the map so that the operator can visualize the location of the human assets with respect to the alert. An alert message may then be automatically sent to each affected asset. Alternatively, or in combination, an operator may type an alert message that is sent to each effected asset. The system may also track responses if a response is requested to indicate which assets have been located and which are presently unaccounted for.

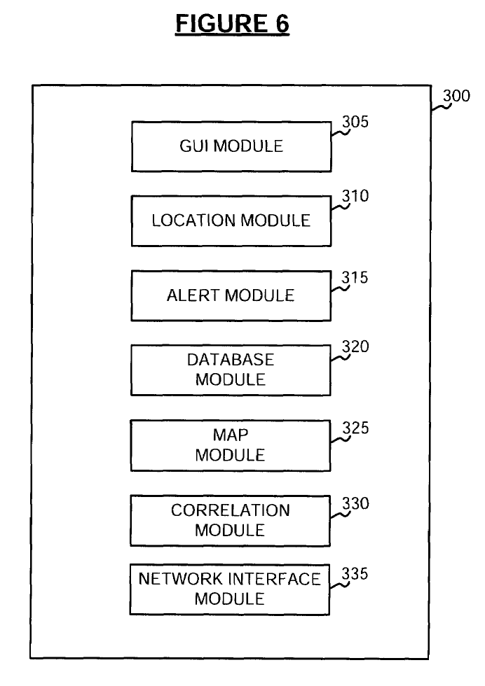

Referring now to FIG. 6, this Figure is a block diagram of an exemplary traveler safety information correlation system according to at least one embodiment of the disclosure. The exemplary system 300 comprises various modules which may provide functionality for providing a traveler safety information correlation system. In the example of FIG. 6, a graphical user interface (GUI) module 305, a location module 310, an alert module 315, a database module 320, a map module 325, a correlation module 330, and a network interface module 335 are shown. It should be appreciated that each module 305, 310, 315, 320, 325, 330, and 335 may be configured as a software application executing on computer hardware, an application specific integrated circuit (ASIC), a combination of hardware and software, combinations of these, or other suitable configuration. Moreover, one or more modules 305, 310, 315, 320, 325, 330, and 335 may be combined or broken into multiple additional modules. Furthermore, modules different than the exemplary ones depicted in FIG. 6 may be used with the various embodiments of the invention.

The network interface module 335 may comprise a network interface card, wireless interface card, wireless broadband card, etc., and corresponding device drivers that may enable two-way communication between the information correlation system, users of the system and human assets over a network such as the network 105 shown in FIG. 1, using a packet-based communication protocol or other suitable protocol.

In various embodiments, the GUI module 305 may comprise a web server or other content generator that allows an operator to interact with the functionality of the TSCS system 300. For example, the GUI module 305 may comprise a network interface front end, such as a web server front end, for providing security and log in functions and also for controlling the backend functionality. The GUI module 305 may provide the interface to the functionality of the system 300 in one or more network browser compliant formats such as HTML, JAVA, XML, etc. Thus, when a system operator accesses the server system 300 via the network, and a page request is received, the module may output the page to the system operator via the network interface module 335. In various embodiments, the GUI module 305 may provide content in the form of an interactive traveler safety control system that allows the operator to monitor travel alerts, locate human assets and generate alert messages from any network node.

In exemplary operations, when a system operator accesses the system 300, the GUI module 305 may authenticate the system operator and present the operator with a menu of choices linked to functionality of various system modules. For example, when checking for travel alerts, the GUI module 305 may invoke the alert module 315 to query one or more alert information sources to determine whether there are any new alerts. The GUI module 305 may receive one or more filter selections from the user which are provided to the alert module 315. For example, the GUI module 305 may receive an indication that the system operator is looking for alerts in the African continent. In such a case, the alert module 315 may request alert information corresponding to the African continent. Any alerts received by the alert module 315 may be output to the operator by the GUI module 305. The GUI module 305 may format raw data received by the alert module 315 into a format that is more easily understood by the operator. For example, in conjunction with the map module 325, the GUI module may prepare a map-based view that illustrates the geographic region corresponding to the alert. The map module 325 may contain map information or may merely be an interface to one or more network-based map content providers (e.g., Google Maps, Yahoo Maps, etc.).

The GUI module 305 may also provide the system operator with a menu selection to access a human asset database so that the operator can begin the process of locating assets that may be affected by the alert. The system operator may input selections via the GUI module 305 to select one or more assets or groups of assets to locate. The GUI module 305 may access the database module 320 to provide the operator with a list of assets and/or groups of assets. Once a selection is made, the GUI module 305 may then access the database module 320 to obtain a data record for the selected asset(s). The location module 310 may then be invoked to obtain location information from one or more location data sources using the information in the data record for the selected asset(s) in a manner consistent with that discussed in the context of FIGS. 1, 3 and 5.

Location information received by the location module 310 as well as alert information from the alert module 315 may be supplied to the correlation module 330. The correlation module 330 may take information from the various data sources and determine which if any human assets are potentially affected by the alert and determine a current location for those assets, as well as any other assets who's location has been requested. Using the map module 325, the GUI module 205 may present the results of the output of the correlation module 330 in a map-based view to the system operator in a manner analogous to that discussed in the context of FIGS. 7-13.

Each module of the system 300 may operate autonomously or under the control of a controller, central processing unit (CPU) or control program, such as a real-time kernel of a control program of the traveler safety information correlation system 300. Furthermore, it should be appreciated that the particular modules illustrated in FIG. 6 are exemplary only and should not be construed as either necessary or exhaustive. In various embodiments, it may be desirable to use more, less or even different modules than those illustrated in FIG. 6. For example, the exemplary system 300 of FIG. 6 may be condensed to four or more modules.

As one exemplary configuration, the system 300 may include a database module that stores information corresponding to a plurality of human assets, such as, an organization's employees, contractors, and consultants. The system 300 may also include a GUI module that generates and outputs a graphical representation, such as a map, that illustrates the location history of one or more of the human assets superimposed on a map. The system 300 may also includes an external data module that receives information from one or more external data sources (e.g., credit card network, cellular phone network, airline reservation system, hotel reservation system, etc.), referred to collectively herein as location data sources. The external data module may also receive situation information from one or more external data systems (e.g., newswire, Internet search engine, etc.), referred to collectively herein as alert data sources. The system 300 may also include a communication module. The communication module may include the functionality of the aforementioned network interface module 335. The communication module may also facilitate communication between server system 300 and users seeking to locate human assets, as well as to deliver information to the human assets themselves over one or more different communication mediums including one or more space-based and terrestrial networks.

FIG. 7 is an exemplary graphical user interface menu of a traveler safety information correlation system according to at least one embodiment of the disclosure. The interface menu 400 of FIG. 7 is an example of a menu that may be presented to a system operator upon accessing the traveler safety control system according to the various embodiments of the disclosure. It should be appreciated that in various embodiments, instead of the menu 400 shown in FIG. 7, the system may output a map view to the user that allows the user to check different portions on the map for human assets. Such variation with in the scope of the various embodiments of the disclosure.

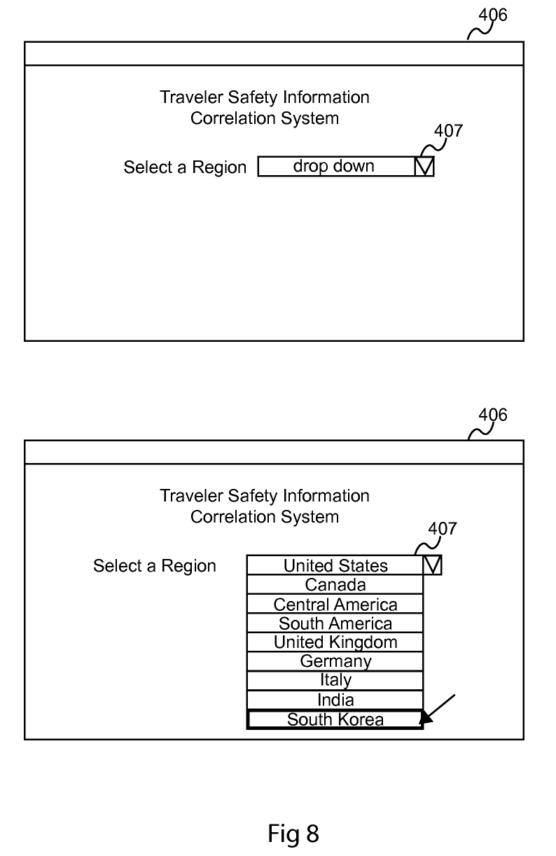

In the example of FIG. 7, the menu 400 includes controls to check for travel alerts 405, locate personnel 410 and send an alert message 415. In various embodiments, the menu may include a flashing icon or other indicator to alert the system operator that one or more new alerts are available. The check for travel alerts control 405 may cause one or more additional interface pages to be presented to the system operator to allow the system operator to tailor the search for alerts, such as limiting it to a particular country, as in the example of FIG. 8. In FIG. 8, after selecting the check for travel alerts control 405 of the menu 400 of FIG. 7, the system operator may be presented with an interface, such as interface 406 that allows the user to select a country or region from a drop down menu 407 to which to search for a corresponding alert. It should be appreciated however, that in various embodiments, a general search for alerts may be performed in response to selecting a control such as control 405 of the menu 400. This may cause the system to query or poll one or more alert data sources in a manner such as discussed herein.

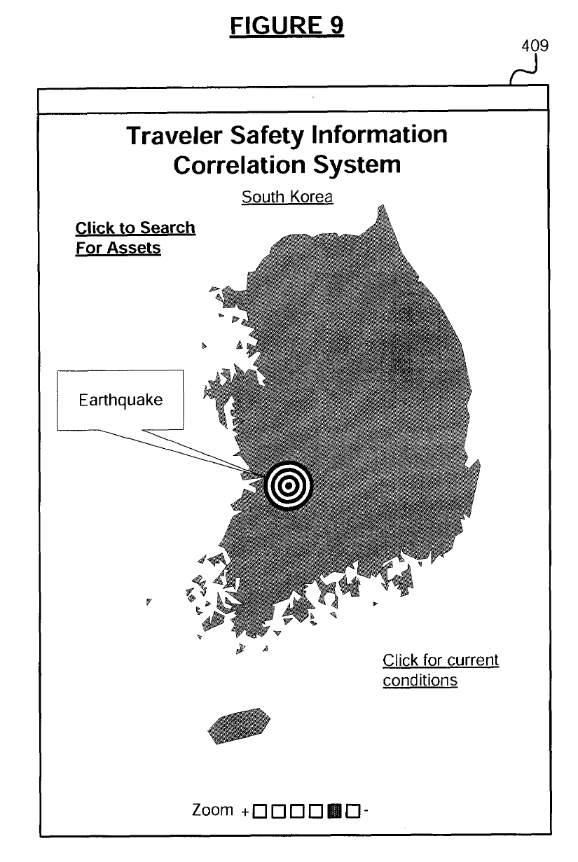

Returning to the example of FIG. 8, in this example, the system operator is selecting the region of Korea from the drop down menu 407. In response to this, the system may check one or more alert data sources for any alerts associated with the country/region of Korea. FIG. 9 illustrates an exemplary graphical user interface window that may be displayed in response to an alert search request such as that of FIG. 8. In the interface window 408 of FIG. 9, a geographical representation (e.g., a map) is depicted. The geographic representation is of a South Korea and includes alert information superimposed thereon. In the example of FIG. 9, an earthquake is shown in the southwestern region of South Korea. In various embodiments, the interface window 408 may include a link to search for human assets, that is, travelers in the region that may be effected by this natural disaster. Selecting this link may cause the system to perform a search of all human assets that may be in the affected area. This may cause the system to access an asset database, to contact one or more location data sources and to correlate the location data to determine if any assets are in the area of interest in a manner consistent with that disclosed herein.

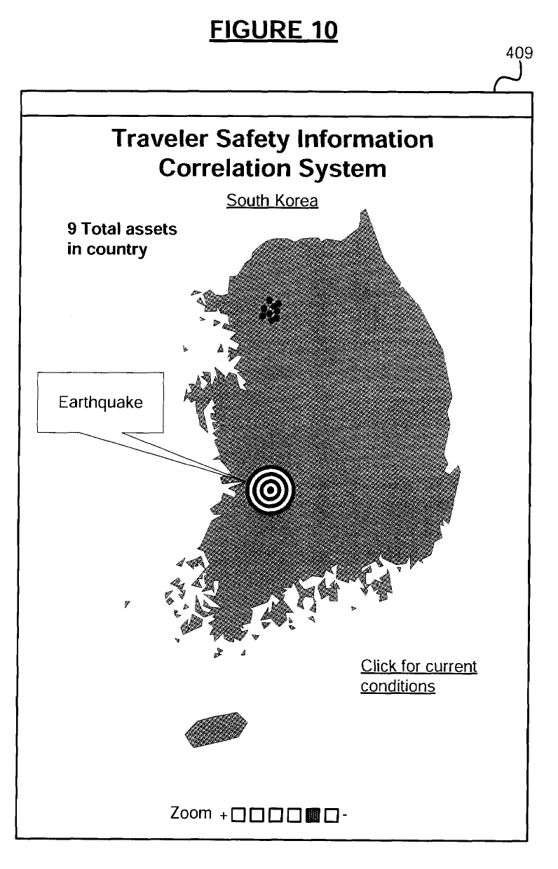

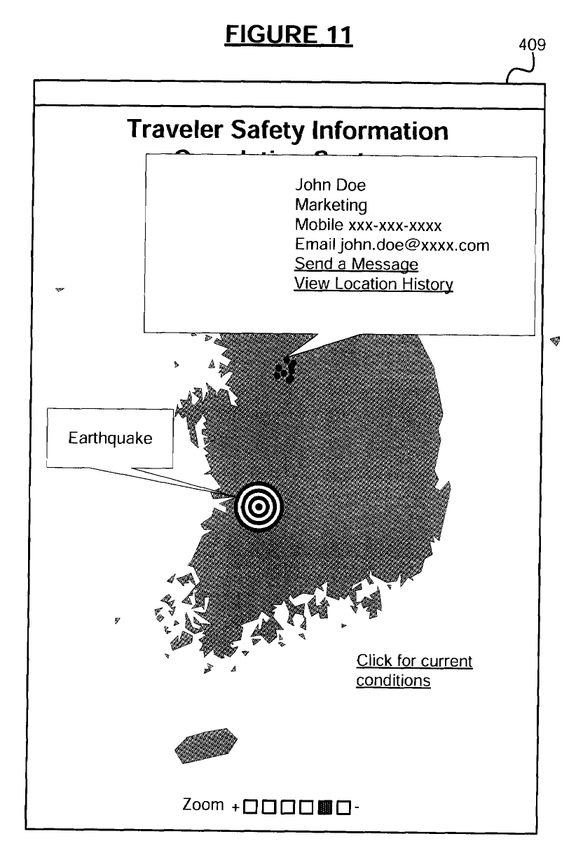

The results of this may be displayed as shown in the example of FIG. 10, where the interface window 409 is updated to show that there are nine human assets in the general area of South Korea. Each of these human assets may be represented in the GUI as a map point located at a location corresponding to the location determined for that asset. As shown in FIG. 11, each map point may be linked to location and identification information for the corresponding human asset. For example, selecting one of the map points may cause a callout block to appear displaying some or all of the identification and location information for the corresponding human asset and providing a link to view the location information that put the asset at that point, as well as one or more links to contact the asset.

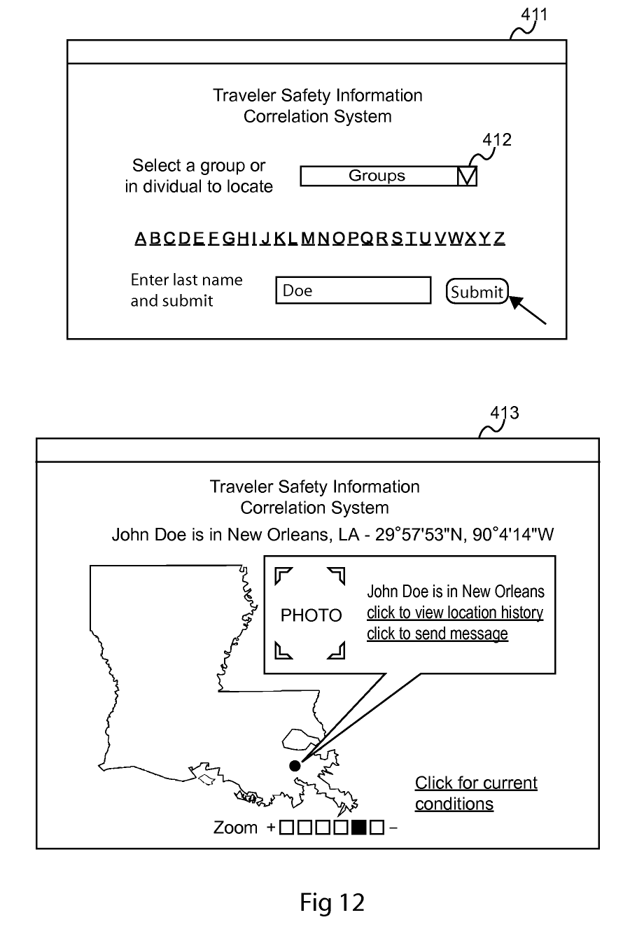

Referring now to FIG. 12, this Figure shows an exemplary graphical user interface of a traveler safety information correlation system including a traveler search function according to at least one embodiment of the disclosure. In various embodiments, the interface 411 is one that may be displayed in response to a system operator selecting the command to locate personnel 410 shown in the menu of FIG. 7. In this example, the operator is provided with a drop down menu 412 as well as a hyperlinked alphabetical search function and a name search tool. In this example, the system operator has done a search for Doe. The search results are displayed in interface 413. After going through location determining steps in back end processing, interface 413 shows that asset John Doe is located in New Orleans. The operator may be presented with a map view of Louisiana as well and John Doe's location is represented with a map point that is linked to his detailed profile and location information.

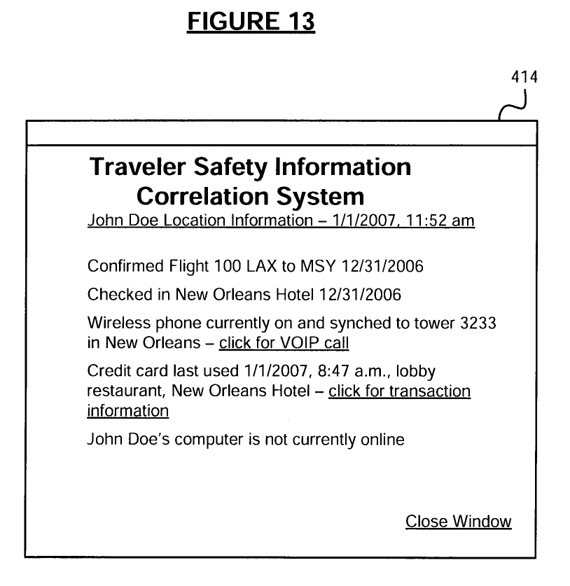

In various embodiments the detailed profile may include a link to view the information that was used to pinpoint the asset's current location, that is the digital footprints left by the asset. FIG. 13 is an example of traveler location information detail. The exemplary record 414 shown in FIG. 13 states that John Doe was confirmed on a flight from LAX to MSY on December 31, and checked into the New Orleans Hotel on the same day, his wireless phone is currently linked to tower 3233 in New Orleans, his credit card was last used the day of the inquiry at 8:47 a.m. in the lobby restaurant of the Hotel, and his computer is not currently online. This information is just one example of the kind of transactional record, (i.e., digital footprint information) that can be used to locate a human asset with the various embodiments of the present disclosure.

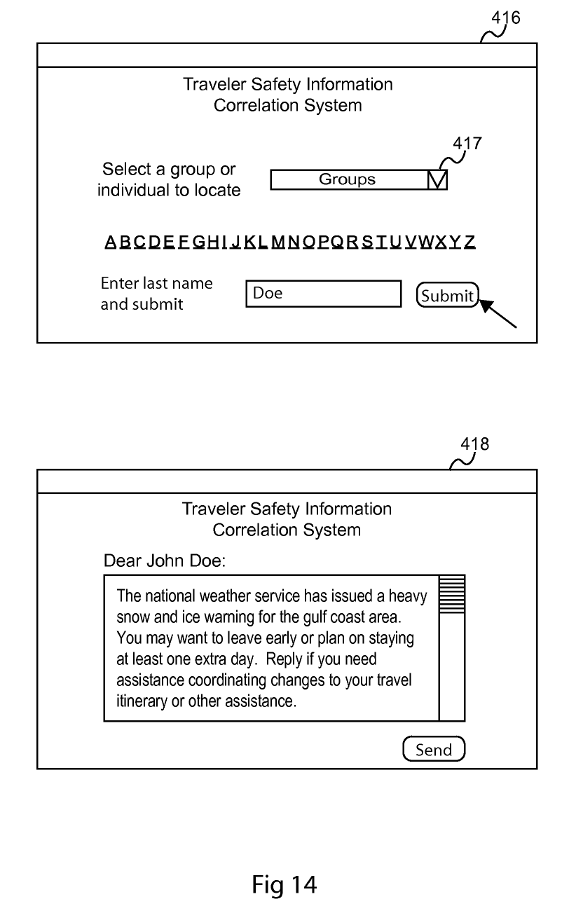

Referring now to FIG. 14, this Figure illustrates an exemplary graphical user interface of a traveler safety information correlation system including a traveler alert messaging function according to at least one embodiment of the disclosure. The interface 416 is one that may be displayed to a system operator in response to the operator selecting a send alert message control 415 such as that shown in FIG. 7. The system operator may be presented with a search window similar to that shown in FIG. 12 that allows the operator to select a group, an individual or to search for an individual to send an alert message to. In the example of FIG. 14, the system operator has selected John Doe to send an alert message to. The system operator may be presented with a message window 418 that allows the system operator to type a customized message to the one or more recipients, in this case, John Doe. In this example, the system operator is sending an electronic mail message to John Doe advising him of a national weather service warning for the gulf coast area, a region that he is currently located in. In various embodiments, the message may include a reply or an acknowledgement control that, upon selection by the recipient, sends an automatic response to the sender to provide “proof of life.” The alert message may be used to send any combination of automated and/or manual messages to the user to provide situational awareness to the asset and to offer assistance. In various embodiments, upon selecting a recipient or group of recipients, the message may be pre-populated with the appropriate address information (email or SMS text message) for each recipient. This information may be stored in a traveler profile database accessible by the TSCS system.

Through the various embodiments disclosed herein, system and methods are provided that allow an organization to monitor for travel alerts from multiple different alert data sources, to locate human assets through multiple different location data sources, to correlate alert and location information to determine assets at risk, to provide geographic context those interacting with the system to display real or near real-time location information for human assets and to allow communication to and with human assets, all from a single system that may be accessed from any network node.

In the preceding specification, various preferred embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than a restrictive sense.

1. A system comprising:
a database module having information corresponding to a plurality of human assets;
a graphical user interface module displaying at least one geographical representation, the geographical representation including one or more points representative of human assets, wherein each of the one or more points are positioned on the geographical representation at locations corresponding to a location of an associated human asset;
an external data module receiving data from two or more electronic information sources, the external data module coding information from the two or more electronic information sources to each of the one or more points, wherein at least one of the two or more electronic information sources provides information corresponding to a recorded location of a human asset, and at least one other of the two or more electronic information sources provides situational information corresponding to the recorded location; and
a communication module for communicating information to the human asset.

2. The system according to claim 1, wherein the graphical user interface comprises a network browser client executing on a computing device.

3. The system according to claim 1, wherein the at least one geographical representation comprises at least one navigable real-time map and each of the one or more points are points on the map representative of at least one recorded geographic location of the associated human asset.

4. The system according to claim 1, wherein the information source providing information corresponding to the recorded location of a human asset comprises at least one source selected from the group consisting of a passenger record system, a flight information system, a hotel reservation system, a financial account system, a GPS/RFID tracking system, a cellular telephone system, and a vehicle location system.

5. The system according to claim 1, wherein the information source providing situation information corresponding to a particular location comprises at least one source selected from the group consisting of a newswire system, an Internet search engine portal, a weather information system, and a travel risk system.

6. The system according to claim 1, wherein each of the one or more points are selectable to display identification information corresponding to the associated human asset.

7. The system according to claim 6, wherein the identification information comprises at least a name, and a last location of the human asset.

8. A traveler information safety correlation apparatus comprising:
a database module containing information on a plurality of human assets;
a graphical user interface module for displaying information on the plurality of human assets in a geographical context, wherein each human asset is coded as a point on an interactive, map;
a external data interface module for receiving electronic data from two or more external information sources;
an alert module for generating a user alert corresponding to one or more human assets based on information from the external data interface module; and
a communication module for sending information to one or more human assets via the graphical user interface module.

9. The system according to claim 8, wherein the plurality of human assets comprise employees of an organization.

10. The system according to claim 8, wherein the graphical user interface module delivers content to a user remotely over a communications network.

11. The system according to claim 8, wherein at least one of the two or more external information sources provides information corresponding to a recorded location of a human asset, and at least one other of the two or more electronic information sources provides situational information corresponding to the recorded location.

12. The system according to claim 11, wherein the information source providing information corresponding to the recorded location of a human asset comprises at least one source selected from the group consisting of a passenger record system, a flight information system, a hotel reservation system, a financial account system, a GPS/RFID tracking system, a cellular telephone system, and a vehicle location system.

13. The system according to claim 11, wherein the information source providing situation information corresponding to a particular location comprises at least one source selected from the group consisting of a newswire system, an Internet search engine portal, a weather information system, and a government-owned travel risk system.

14. The system according to claim 8, wherein each points is selectable to display identification information corresponding to the associated human asset.

15. The system according to claim 14, wherein the identification information comprises at least a name, and a last location of the human asset.

16. A method comprising:
populating a database of human asset information;
determining a location of one or more of the human assets;
identifying warning information associated with the location; and
outputting a user alert to a graphical user interface if a location of at least one of the human assets has warning information associated with it.

17. The method according to claim 16, wherein determining a location of one or more of the human assets comprises, for each human asset, receiving information from at least one electronic information source selected from the group consisting of a passenger record system, a flight information system, a hotel reservation system, a financial account system, a GPS/RFID tracking system, a cellular telephone system, and a vehicle location system.

18. The method according to claim 16, wherein identifying warning information associated with the location comprises receiving data from at least one source selected from the group consisting of a newswire system, an Internet search engine portal, a weather information system, and a government-owned travel risk system.

19. The method according to claim 16, further comprising outputting a geographic representation including representations of each human asset as a point on an interactive map to a graphical user interface, wherein each asset is represented by a point located on the geographic representation at the determined location for that human asset.

20. The method according to claim 19, further comprising outputting identification information about a human asset when the point associated with that asset is selected on the graphical user interface, wherein displaying, wherein outputting identification information comprises displaying at least a name and a location of the human asset.
